(19) United States
(12) Patent Application Publication
(10) Pub. No.: US 2026/0219703 A1
(43) Pub. Date: Jul. 30, 2026

(54) SYSTEM AND METHOD FOR DETECTING DEVIATIONS IN HARDWARE TIMERS

(71) Applicant: Microchip Technology Incorporated, Chandler, AZ (US)

(72) Inventor: Daniel Costin, Bucharest (RO)

(21) Appl. No.: 19/401,613

(22) Filed: Nov. 26, 2025

Related U.S. Application Data
(60) Provisional application No. 63/751,556, filed on Jan. 30, 2025.

(51) Int. Cl. G06F 1/14; G06F 1/12; G06F 9/30; G06F 9/48; G06F 11/07

(52) U.S. Cl. CPC G06F 1/14; G06F 1/12; G06F 9/30101; G06F 9/4812; G06F 11/0754

(57) ABSTRACT

Systems and methods are disclosed for detecting deviations in hardware timer operations. A system may include a first timer driven by a first clock source to produce a first timer value, while a second timer may be driven by a second, independent clock source to produce a second timer value. A deviation logic hardware block may compute a complement of the first timer value, calculate a difference between the complemented value and the second timer value, and compare the difference to a deviation limit to determine whether a deviation has occurred.

### CROSS-REFERENCE TO RELATED APPLICATION

The present application claims priority from U.S. Provisional Patent Application No. 63/751,556, filed Jan. 30, 2025, which is incorporated herein by reference in its entirety.

### TECHNICAL FIELD

The present disclosure relates generally to hardware-based monitoring systems for timer operations, and more specifically to systems and methods for detecting deviations in hardware timers.

### BACKGROUND

Computing systems, including embedded architectures, commonly employ timers, counters, and associated clock sources to regulate task execution, coordinate interrupt scheduling, and enforce temporal requirements. Conventional approaches integrate one or more subsystems, typically configured through prescalers, comparators, and threshold registers. These timers are used for measuring elapsed time, generating periodic interrupts, and ensuring synchronization of real time processes in safety critical and general purpose applications. Software based, application level, monitoring techniques where redundant timer resources are employed under a 1 out of 1 (1oo2) redundancy scheme may also be used, with comparisons executed in application code or interrupt service routines to assess timer consistency.

In operation, software driven timer monitoring relies on periodic register access and tolerance checks performed at the application layer. These operations are subject to scheduling delays, interrupt prioritization, and processor loading conditions, which can introduce detection latency between the occurrence of a timing fault and its recognition. The repeated execution of comparison algorithms also consumes computational cycles and memory bandwidth, thereby limiting system capacity available for primary functions. Moreover, the monitoring logic itself constitutes a potential single point of failure, as corruption in the application code can render fault detection ineffective. Because both the monitored function and the monitoring logic may execute on the same processor core and share common resources, such approaches are further exposed to common cause failures that compromise diagnostic independence.

Accordingly, there is a need for improved systems and methods that enhance the reliability of timer monitoring in embedded and real time environments. Such improvements may provide continuous diagnostic capability while reducing reliance on application level execution paths, thereby mitigating latency in fault recognition and limiting consumption of processor resources. Improvements in timer monitoring architectures may also address resilience against single points of failure and may reduce exposure to common cause software or hardware faults. Technical approaches of this nature may advance the dependability of embedded controllers and support compliance with established functional safety standards.

### SUMMARY

One or more examples may provide systems and methods for deviation detection in timer based architectures implemented directly in hardware. In contrast to conventional software-based monitoring approaches that rely on periodic polling and consume processor resources, the architecture according to one or more examples may perform continuous evaluation of timer outputs in hardware circuitry. By operating independently of application level execution paths and employing timers driven by separate clock domains, the one or more examples may reduce latency in deviation detection, improve runtime efficiency, and enhance diagnostic coverage through deterministic, hardware processing.

According to an aspect of one or more examples, there is provided a system for detecting deviations in hardware timer operations. The system may include a first timer driven by a first clock source, and to output a first timer value, a second timer driven by a second clock source, independent of the first clock source, and to output a second timer value, a deviation logic hardware block (DLHB) to compute a complement of the first timer value, calculate a difference between the complement of the first timer value and the second timer value, and compare the difference to a predefined deviation limit to determine whether a deviation has occurred. The DLHB may output a deviation flag in response to determining that the calculated difference exceeds the predefined deviation limit. The system may include a deviation limit register configurable to store a predefined deviation limit. The system may include a first period register to store a first threshold, a first comparator to compare the first timer value to the first threshold, and an event interrupt circuit to generate an interrupt signal in response to the first timer value matching the first threshold. The first timer may count upwards and the second timer may count downwards. The system may include a second period register to store a second threshold, a second comparator to compare the second timer value to the second threshold, and generate a reference signal in response to determining that the second timer value matches the second threshold. The system may be configured to generate a valid timer interrupt in response to the generation of the interrupt signal and the determination of the DLHB that no deviation has occurred. The system may be configured to generate a fault signal in response to the generation of the interrupt signal and the determination of the DLHB that a deviation has occurred The first clock source and the second clock source may be derived from independent prescalers. The system may include a synchronous timer enable circuit to synchronize the first timer and the second timer.

According to an aspect of one or more examples, there is provided a method for detecting deviations in hardware timer operations. The method may include driving a first timer with a first clock source to output a first timer value, driving a second timer with a second clock source, independent of the first clock source, to output a second timer value, computing a complement of the first timer value, calculating a difference between the complement of the first timer value and the second timer value, comparing the calculated difference to a predefined deviation limit, and generating a deviation flag in response to determining that the calculated difference exceeds the predefined deviation limit. The method may include comparing the first timer value to a first threshold, and generating an interrupt signal in response to the first timer value matching the first threshold. The method may include comparing the second timer value to a second threshold, and generating a reference signal in response to the second timer value matching the second threshold. The first timer may count upwards and the second timer may count downwards. The method may include generating a valid timer interrupt in response to the generation of the interrupt signal and determining that no deviation has occurred. The method may include generating a fault signal in response to the generation of the interrupt signal and the generation of the deviation flag.

According to an aspect of one or more examples, there is provided an apparatus for detecting deviations in hardware timer operations. The apparatus may include a first timer configured to be driven by a first clock source and output a first timer value. The apparatus may include a first period register to store a first threshold. The apparatus may also include a first comparator to compare the first timer value to the first threshold. The apparatus may further include an event interrupt circuit to generate an interrupt signal in response to the first timer value matching the first threshold. The apparatus may include a second timer configured to be driven by a second clock source, independent of the first clock source, and to output a second timer value. The system may further include a deviation logic hardware block (DLHB) to: compute a complement of the first timer value, calculate a difference between the complement of the first timer value and the second timer value, and compare the difference to a predefined deviation limit to determine whether a deviation has occurred. The system may include a first logic circuit to generate a valid timer interrupt in response to the interrupt signal and determining that a deviation has not occurred. The system may include a second logic circuit to generate a fault signal in response to the interrupt signal and determining that a deviation has occurred. The system may include a second period register to store a second threshold, and a second comparator to compare the second timer value to the second threshold and generate a reference signal in response to determining that the second timer value matches the second threshold. The first timer may increment, and the second timer may decrement.

### BRIEF DESCRIPTION OF DRAWINGS

FIG. 1 shows a block diagram of a hardware-based system for detecting deviations in timer operations according to various examples.

FIG. 2 illustrates hardware-based system behavior when the timers operate within their expected parameters, resulting in a valid interrupt according to FIG. 1.

FIG. 3 illustrates hardware-based system behavior when a deviation occurs between the timers, resulting in an error interrupt according to FIG. 1.

FIG. 4 shows a flow chart of a method for detecting deviations in hardware timers according to various examples.

### DETAILED DESCRIPTION OF VARIOUS EXAMPLES

Reference will now be made in detail to the following various examples, which are illustrated in the accompanying drawings, wherein like reference numerals refer to like elements throughout. The following examples may be embodied in various forms without being limited to the examples set forth herein.

In safety-related systems, timer modules are components that control software processes and tasks, often through timer interrupts. Deviations in timer operation, such as clock source errors or hardware malfunctions in the timers, can lead to erroneous system events, posing significant risks to system reliability and compliance with safety standards.

Existing solutions for timer deviation detection often rely on software-based mechanisms that consume CPU cycles and may introduce latency in operations. These approaches may not meet the stringent performance and reliability requirements of safety standards such as ISO 26262 and IEC 61508, which mandate robust monitoring mechanisms for functional safety.

Therefore, there exists a need for a more efficient and reliable method to detect timer deviations in hardware, without burdening the CPU, to ensure compliance with safety standards and enhance system performance.

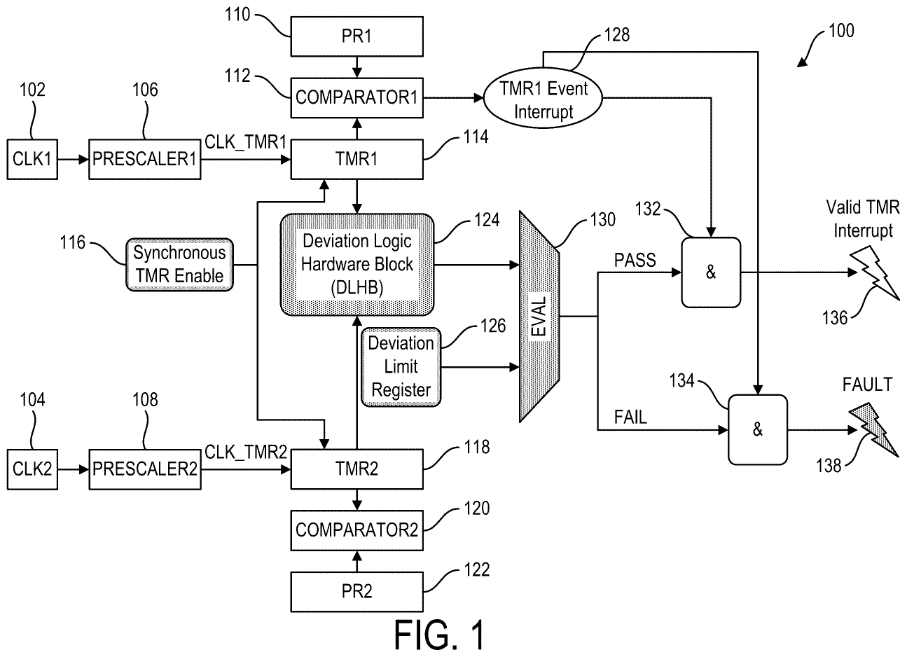

FIG. 1 shows a block diagram of a hardware-based system 100 for detecting deviations in timer operations according to various examples. The system 100 may include, among other components, independent clock sources, timers, and a Deviation Logic Hardware Block (DLHB) 124. The system 100 may provide a robust and efficient mechanism for detecting faults in timer modules without requiring CPU intervention, enhancing system reliability and performance.

Two independent clock sources, CLK1 102 and CLK2 104, may be fed into respective prescalers, PRESCALER1 106 and PRESCALER2 108. The prescalers may divide the clock frequencies to generate derived clock signals, CLK_TMR1 and CLK_TMR2, which may be used to drive two timer modules, TMR1 114 and TMR2 118. For example, if CLK1 102=16 MHz and PRESCALER1 106=2, then CLK_TMR1=8 MHz, and if CLK2 104=16 MHz and PRESCALER2 108=2, then CLK_TMR2=8 MHz. As another example, if CLK1 102=8 MHz and PRESCALER1 106=2, then CLK_TMR1=4 MHz, and if CLK2 104=32 MHz and PRESCALER2 108=8, then CLK_TMR2=4 MHz.

Each timer module may be associated with a period register, PR1 110 for TMR1 114 and PR2 122 for TMR2 118, which may define the time or period for the respective timers. For example, TMR1 114 may operate as an up-counter, incrementing its value until it reaches the threshold set by PR1 110, at which point it resets to 0 and starts counting again. Similarly, TMR2 118 may operate as a down-counter, decrementing its value until it matches PR2 122, after which it resets to its initial value. For 8-bit timers, TMR1 114 may be initialized with 0x00 and start counting by incrementing the value, and TMR2 118 may be initialized with 0xFF and start counting by decrementing the value. The Synchronous TMR Enable block 116 may ensure that both timers TMR1 114 and TMR2 118 are activated and operate in a coordinated manner, thereby ensuring that both timers begin counting in a synchronized manner for accurate deviation analysis. The Synchronous TMR Enable block 116 may synchronize the start and operation of the two independent timers to ensure accurate deviation detection.

The outputs of the timers TMR1 114 and TMR2 118 may be monitored by COMPARATOR1 112 and COMPARATOR2 120, respectively. COMPARATOR1 112 may compare the value of TMR1 114 with the predefined threshold stored in PR1 110. When TMR1 114 reaches this threshold, COMPARATOR1 112 may generate a signal to trigger the TMR1 Event Interrupt 128, which may serve as the primary interrupt signal for the system. This interrupt may indicate the completion of a timing cycle or another predefined event in TMR1's 114 operation. Similarly, COMPARATOR2 120 may compare the value of TMR2 118 with the threshold in PR2 122 and generate a reference signal that ensures synchronization between the two timers.

The DLHB 124 may serve as the core detection mechanism of the system 100. The DHLB 124 may operate by computing the complement of TMR1's 114 value (cTMR1), calculating the difference between cTMR1 and the value of TMR2 118 (or vice versa), and checking the result against a Deviation Limit Register 126, which may store a user-configurable deviation threshold. If the calculated deviation is within an acceptable range, the system 100 may pass the validation step, and a Valid TMR Interrupt may be generated. This may indicate that both timers TMR1 114 and TMR2 118 are functioning correctly and there are no detectable faults. Conversely, if the deviation exceeds the threshold stored in the Deviation Limit Register 126, the DLHB 124 may flag a fault condition. The DLHB 124 may then trigger a “FAIL” signal, which may be routed to the fault handling logic for further action.

To handle the evaluation and routing of the system's 100 outputs, the system 100 may include a multiplexer (EVAL) 130. The multiplexer 130 may select or route signals from the DLHB 124 based on the outcome of the deviation checks. If the deviation is within acceptable limits, the multiplexer 130 may route the “PASS” signal to a first AND gate 132, which is configured to receive the TMR1 Event Interrupt 128 and generate a valid TMR interrupt 136 upon receiving both the PASS signal and the TMR1 Event Interrupt 128. However, if the DLHB 124 detects a fault, the multiplexer 130 may route the “FAIL” signal to a second AND gate 134 to trigger a fault response 138 upon receiving the TMR1 Event Interrupt 128 and the FAIL signal. This may ensure that the system 100 reliably processes and communicates the results of its timer deviation evaluations.

By leveraging hardware-level detection, the system 100 may avoid the latency and computational overhead associated with software-based monitoring. The use of independent clock sources and configurable thresholds may provide high fault-detection accuracy while maintaining flexibility for different system requirements. The system 100 may be broadly applicable to any microcontroller or microprocessor system calling for reliable timer deviation detection.

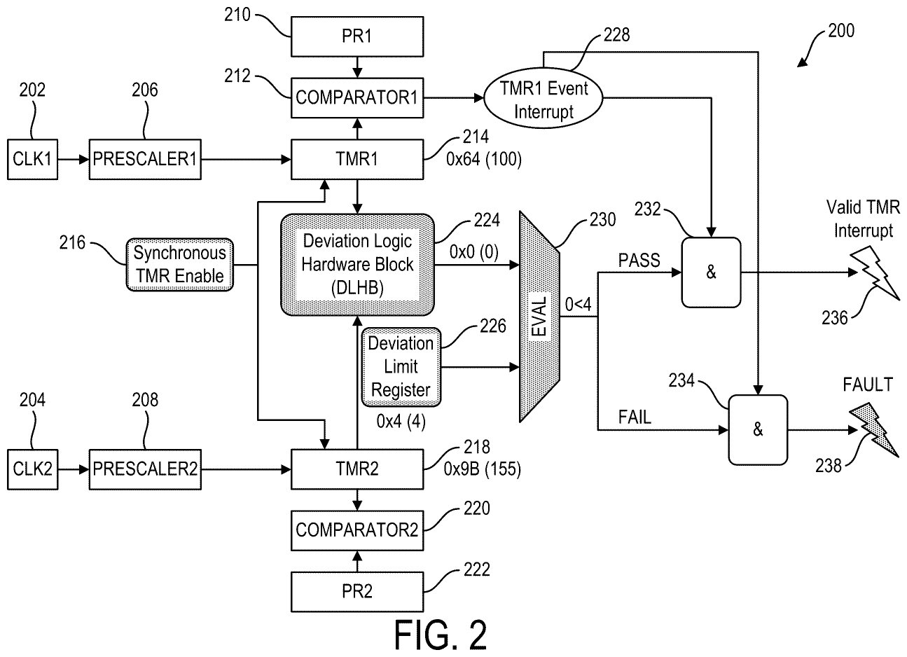

FIG. 2 illustrates the hardware-based system 100 behavior when the timers operate within their expected parameters, resulting in a valid interrupt according to FIG. 1. As with FIG. 1, FIG. 2 also depicts: two independent clock sources, CLK1 202 and CLK2 204, respective prescalers, PRESCALER1 206 and PRESCALER2 208, period registers, PR1 210 and PR2 222. These features may operate in substantially the same manner as discussed in the description of FIG. 1.

The Synchronous TMR Enable block 216 may ensure that both timers TMR1 214 and TMR2 218 are activated and operate in a coordinated manner, so that deviation checks are performed against aligned timer cycles rather than skewed starting points. TMR1 214 may operate as an up-counter, incrementing from an initial value until it reaches PR1 210, at which point COMPARATOR1 212 may trigger the TMR1 214 Event Interrupt 228. In some examples, COMPARATOR2 220 may similarly generate a TMR2 Event Interrupt when TMR 218 reaches PR2 222, thereby providing an additional diagnostic signal for deviation checks.

In the example of FIG. 2, the value of TMR1 214 may be 0x64 (100). TMR2 218 may operate as a down-counter, decrementing from an initial value until it reaches the threshold stored in PR2 222. In the example of FIG. 2, the value of TMR2 218 may be 0x9B (155). The DLHB may compare TMR 1 214 and TMR2 218 using a deviation detection mechanism. The DHLB 224 may operate by computing the complement of TMR1's 214 value (cTMR1), calculating the difference between cTMR1 and the value of TMR2 218 (or vice versa), and checking against the Deviation Limit Register 226. In this valid operation, the calculated difference is 0x0 (0 ), which may be within the permissible deviation limit 0x4 (4). The multiplexer 230 may process the output from the DLHB 224. Since the difference is acceptable (0<4), the “PASS” signal 232 may be activated, and a Valid TMR Interrupt 236 may be generated.

In some examples, the complement of the first timer value (cTMR1) may be determined by performing a bitwise inversion of each bit in the current TMR1 count across the timer's width. For an 8-bit timer, this means that every binary 0 is flipped to 1 and every binary 1 is flipped to 0. For example, if TMR1 holds the value 0x64 (binary 0110 0100, decimal 100), its complement is computed as 1001 1011, which corresponds to 0x9B (decimal 155). The DLHB may then calculate a difference between this complemented value of TMR1 and the current value of TMR2. The absolute value of the difference is compared against a deviation limit stored in the deviation limit register 226. If the difference is less than or equal to the deviation limit, the DLHB 224 outputs a PASS condition 232; if the difference exceeds the deviation limit, the DLHB 224 outputs a FAIL condition 234.

In some examples, the multiplexer 230 receives the PASS 232 and FAIL 234 signals and coordinates them with timer interrupts to determine final outputs. As shown in FIG. 2, an AND gate 232 is configured to combine the PASS signal with the TMR1 Event interrupt 228 to generate a Valid TMR Interrupt 236. A second AND gate 234 is configured to combine the FAIL signal with additional diagnostic logic to assert a FAULT output 238. This ensures that properly validated interrupts propagate to the system, while detected deviations raise a fault condition.

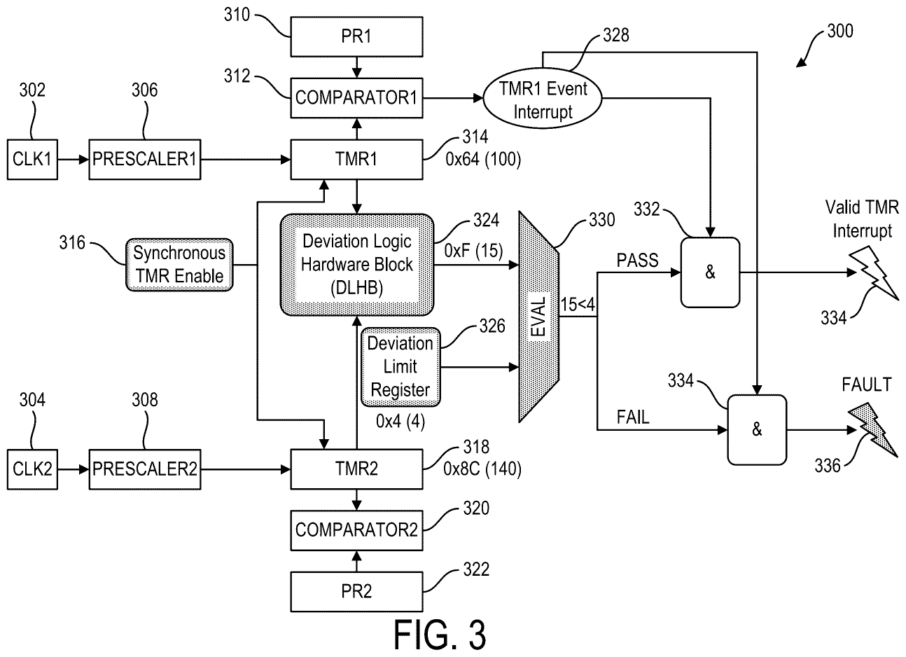

FIG. 3 illustrates the hardware-based system 100 behavior when a deviation occurs between the timers, resulting in an error interrupt according to FIG. 1. The system 300 includes two independent clock sources (CLK1 302 and CLK2 304, respective prescalers (PRESCALER1 306 and PRESCALER2 308), two timer modules (TMR1 314 and TMR2 318), associated period registers (PR1 310 and PR2 322), and comparators (COMPARATOR1 312 AND COMPARATOR2 320). A synchronous TMR enable block 316 may coordinate activation of the two timers to ensure aligned operation for deviation analysis.

In the example of FIG. 3, TMR1 314 may operate as an up-counter and hold the value 0x64 (decimal 100), while TMR2 318 may operate as a down-counter and hold the value 0x8C (decimal 140). The DLHB 324 may operate by computing the complement of TMR1's 314 value (cTMR1), by performing a bitwise NOT inversion across the 8 bit timer width, flipping every binary 0 to 1 and every binary 1 to 0. For instance, the bitwise invention of 0x64 (binary 0110 0100) produces 0x9B (binary 1001 1011, decimal 155). The DLHB 324 may then calculate the absolute difference between cTMR1 (decimal 155) and the current value of TMR2 318 (decimal 140) (or vice versa), and checking against the Deviation Limit Register 326. The computed difference may be 0x0F (decimal 15), which may exceed the deviation limit 0x4 (decimal 4) stored in the Deviation Limit Register 326 (e.g., a threshold of 4). As the computed difference |155−140|=15 exceeds the allowed limit 0x4 (4), the DLHB 324 may trigger a fault signal 336. The multiplexer 330 may process the output from the DLHB 324. In this case, the “FAIL” signal 334 may be activated, and the system 100 may generate a FAULT output 336 rather than a valid interrupt. Conversely, a PASS signal 332 would be produced if the deviation were less than or equal to the stored deviation limit, in which case the TMR1 Event Interrupt 328 could be combined with the PASS signal 332 to generate a Valid TMR Interrupt 334.

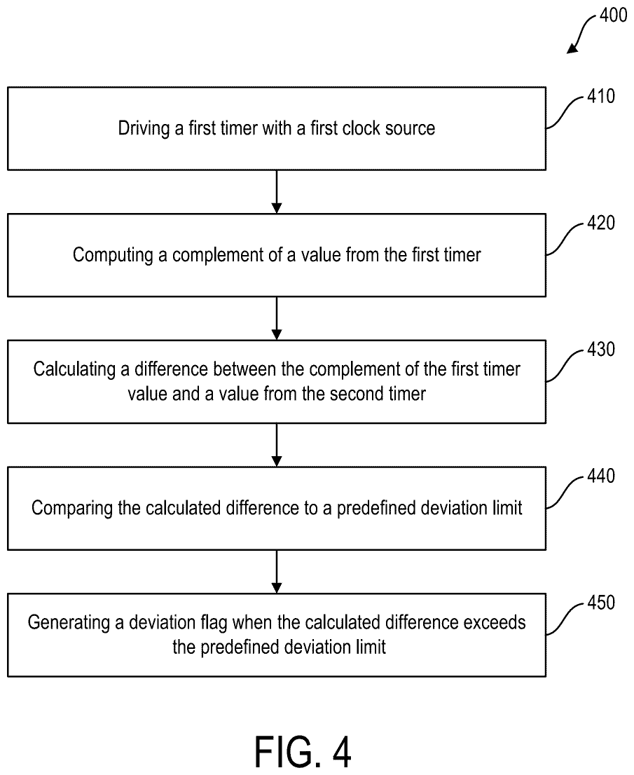

FIG. 4 shows a flow chart of a method 400 for detecting deviations in hardware timers according to various examples. Method 400 may be implemented by one or more components of the systems illustrated in FIGS. 1-3 (e.g., system 100, 200, and 300), where components such as timers TMR1 (e.g., 114/214/314) and TMR2 (e.g., 118/218/318), prescalers (e.g., 106/206/306 and 108/208/308), comparators (e.g., 112/212/312 and 120/220/320), and the Deviation Logic Hardware Block DLHB (e.g., 124/224/324) perform the corresponding operations. At step 410, the method may involve driving a first timer with a first clock source. This step may be performed by supplying a first clock signal (e.g., CLK1 102) to a first prescaler (e.g., PRESCALER1 106), which derives a first timer clock (CLK_TMR1) used to advance a first timer (e.g., TMR1 114) implemented in hardware. In parallel, a second clock signal (e.g., CLK2 104), independent of the first clock signal, may be supplied to a second prescaler (e.g., PRESCALER3 108), which derives a second timer clock (CLK_TMR2) used to advance a second timer (TMR2). In certain examples described with respect to FIGS. 1-3, TMR1 may be configured as an up counter and TMR2 as down counter, with both timers optionally enabled in coordination by synchronous enable circuit (e.g., synchronous TMR enable 116) to ensure aligned evaluation intervals.

At step 420 the method may involve computing a complement of a value from the first timer. This step may be performed by obtaining the current count value from the first timer (TMR1) and applying a bitwise NOT operation across the timer width to produce a complemented timer value (cTMR1). For an 8-bit timer, each binary 0 is inverted to 1 and each binary 1 is inverted to 0, resulting in a value between 0x00 and 0xFF. The complement operation provides a reference value against which the current value of the second timer (TMR2), driven independently by CLK2 through PRESCALER2, will later be capered. By coupling the complemented value of TMR1 with the independently generated value of TMR2, the method establishes the two operands required for deviation detection.

At step 430 the method may involve calculating a difference between the complement of the first timer value and a value from the second timer. This step may be performed by providing the complemented value of the first timer (cTMR1), as computed in step 420, together with a contemporaneous value from the second timer (TMR2), which is driven by an independent clock source (CLK2) through a second prescaler (PRESCALER2). The DLHB (e.g., DLHB 124) determines a difference value by subtracting one value from the other and taking the absolute value of the result, expressed as Diff=|cTMR1−TMR2|.

At step 440 the method may involve comparing the calculated difference to a predefined deviation limit. This step may be performed by supplying the difference value (e.g., DIFF from step 430), calculated in step 430, to comparator circuitry associated with the DLHB. The DLHB may retrieve a deviation limit (which may be predefined) from a configurable deviation limit register (e.g., deviation limit register 126) and compare it to the difference value (i.e., Diff). If the difference value is less than or equal to the deviation limit, the condition may be classified as within tolerance; if the difference value exceeds the deviation limit, the condition may be classified as outside tolerance. This comparison establishes the basis for generating either a PASS or FAIL output.

At step 450 the method may involve generating a deviation flag when the calculated difference exceeds the predefined deviation limit. This step may be performed by creating a deviation flag when the comparison of step 440 indicates that the calculated difference value (i.e., Diff) is greater than the deviation limit stored in the Deviation Limit Register (e.g., deviation limit register 126). When the deviation flag is asserted, a multiplexer (e.g., EVAL 130) may generate a FAIL signal (e.g., FAIL 134) and gating circuitry (e.g., AND gates as shown in FIGS. 1-3) to assert a FAULT output 138, thereby inhibiting the generation of a valid timer interrupt. When the difference value is less than or equal to the deviation limit, the deviation flag remains de-asserted, and a PASS signal (e.g., PASS 132) condition may be routed to gating logic so that, in conjunction with a timer event signal, a Valid TMR Interrupt (e.g., Valid TMR Interrupt 136) is generated.

Various examples have been disclosed herein, in connection with the above description and the drawings. It will be understood that it would be unduly repetitious to literally describe and illustrate every combination and subcombination of these examples. Accordingly, all examples can be combined in any way or combination, and the present specification, including the drawings, shall be construed to constitute a complete written description of all combinations and subcombinations of the examples described herein, and of the manner and process of making and using them, and shall support claims to any such combination or subcombination.

It will be appreciated by persons skilled in the art that the examples described herein are not limited to what has been particularly shown and described herein above. In addition, unless mention was made above to the contrary, it should be noted that all of the accompanying drawings are not to scale. A variety of modifications and variations are possible in light of the above teachings.

What is claimed is:

1. A system for detecting deviations in hardware timer operations, comprising:
a first timer configured to be driven by a first clock source and to output a first timer value;
a second timer configured to be driven by a second clock source, independent of the first clock source, and to output a second timer value;
a deviation logic hardware block (DLHB) to:
compute a complement of the first timer value;
calculate a difference between the complement of the first timer value and the second timer value; and
compare the difference to a predefined deviation limit to determine whether a deviation has occurred.

2. The system of claim 1, wherein the DLHB is configured to output a deviation flag in response to determining that the calculated difference exceeds the predefined deviation limit.

3. The system of claim 1, further comprising a deviation limit register configurable to store the predefined deviation limit.

4. The system of claim 1, comprising:
a first period register to store a first threshold;
a first comparator to compare the first timer value to the first threshold; and
an event interrupt circuit to generate an interrupt signal in response to the first timer value matching the first threshold.

5. The system of claim 4, wherein the first timer is to count upwards and the second timer is to count downwards.

6. The system of claim 4, comprising:
a second period register to store a second threshold;
a second comparator to compare the second timer value to the second threshold, and generate a reference signal in response to determining that the second timer value matches the second threshold.

7. The system of claim 4, wherein the system is configured to generate a valid timer interrupt in response to the generation of the interrupt signal and the determination of the DLHB that no deviation has occurred.

8. The system of claim 4, wherein the system is configured to generate a fault signal in response to the generation of the interrupt signal and the determination of the DLHB that a deviation has occurred.

9. The system of claim 1, wherein the first clock source and the second clock source are derived from independent prescalers.

10. The system of claim 1, comprising a synchronous timer enable circuit to synchronize the first timer and the second timer.

11. A method for detecting deviations in hardware timer operations, the method comprising:
driving a first timer with a first clock source to output a first timer value;
driving a second timer with a second clock source, independent of the first clock source, to output a second timer value;
computing a complement of the first timer value;
calculating a difference between the complement of the first timer value and the second timer value;
comparing the calculated difference to a predefined deviation limit; and
generating a deviation flag in response to determining that the calculated difference exceeds the predefined deviation limit.

12. The method of claim 11, comprising:
comparing the first timer value to a first threshold; and
generating an interrupt signal in response to the first timer value matching the first threshold.

13. The method of claim 12, comprising:
comparing the second timer value to a second threshold; and
generating a reference signal in response to determining that the second timer value matches the second threshold.

14. The method of claim 12, wherein the first timer counts upwards and the second timer counts downwards.

15. The method of claim 12, comprising generating a valid timer interrupt in response to the generation of the interrupt signal and determining that no deviation has occurred.

16. The method of claim 12, comprising generating a fault signal in response to the generation of the interrupt signal and the generation of the deviation flag.

17. An apparatus for detecting deviations in timer operations, the apparatus comprising:
a first timer configured to be driven by a first clock source and output a first timer value;
a first period register to store a first threshold;
a first comparator to compare the first timer value to the first threshold;
an event interrupt circuit to generate an interrupt signal in response to the first timer value matching the first threshold;
a second timer configured to be driven by a second clock source, independent of the first clock source, and to output a second timer value;
a deviation logic hardware block (DLHB) to:
compute a complement of the first timer value;
calculate a difference between the complement of the first timer value and the second timer value; and
compare the difference to a predefined deviation limit to determine whether a deviation has occurred; and
a first logic circuit to generate a valid timer interrupt in response to the interrupt signal and determining that a deviation has not occurred.

18. The apparatus of claim 17, comprising a second logic circuit to generate a fault signal in response to the interrupt signal and determining that a deviation has occurred.

19. The apparatus of claim 18, comprising:
a second period register to store a second threshold; and
a second comparator to compare the second timer value to the second threshold, and generate a reference signal in response to determining that the second timer value matches the second threshold.

20. The apparatus of claim 17, wherein the first timer increments and the second timer decrements.
